(19) United States
(12) Patent Application Publication
(10) Pub. No.: US 2015/0024219 A1
(43) Pub. Date: Jan. 22, 2015

(54) AROMATIC SECONDARY ADHESIVE COMPOSITIONS CONTAINING AMINOSILANE

(71) Applicant: SIKA TECHNOLOGY AG, Baar (CH)

(72) Inventors: Reto DOHNER, Zurich (CH); Michael SCHLUMPF, Stallikon (CH); Andreas DIENER, Wald ZH (CH); Wolf-Rüdiger HUCK, Gockhausen (CH)

(21) Appl. No.: 14/469,174

(22) Filed: Aug. 26, 2014

Related U.S. Application Data
(63) Continuation of application No. 12/994,580, filed on Nov. 24, 2010, now abandoned.

(30) Foreign Application Priority Data
May 28, 2008 (EP) 08157104.4

(51) Int. Cl. C09D 5/00; C08K 5/548; C08K 5/544; B32B 37/12; C09J 7/02; B32B 7/12; B32B 17/06; B32B 33/00; C09D 7/12; C09D 163/00

(52) U.S. Cl. CPC C09D 5/002; C09D 7/1233; C08K 5/548; C08K 5/544; C09D 163/00; C09J 7/0257; B32B 7/12; B32B 17/06; B32B 33/00; B32B 37/12; C09J 2475/00; C09J 2400/223; C09J 2400/143; B32B 2250/02; B32B 2255/24
USPC 428/429; 523/400; 106/287.11; 156/314; 156/310

(57) ABSTRACT

Compositions having i) at least one mercaptosilane MS, as well as ii) at least one polysilane PS, as well as iii) at least one aromatic secondary aminosilane AS, as well as iv) at least one organotitanium compound.

This application is a continuation of application Ser. No. 12/994,580, filed Nov. 24, 2010, which in turn is a National Phase of International Application PCT/EP2009/056566, filed May 28, 2009, and which claims priority to European Patent Application No. 08157104.4 filed May 28, 2008, the contents of which are incorporated herein by reference in their entirety.

### BACKGROUND

The present invention relates to the field of adhesion promoters.

Adhesive bonding is a widely used bonding technology. In view of the large number of possible substrates which are bonded to each other, there are always substrates which cannot develop any or sufficient adhesion with certain adhesives. For quite some time adhesion promoters, in particular primers, have been used to improve adhesion of adhesives and sealants to these substrates.

Usually silanes, often also as mixtures, are used as adhesion promoters. WO-A-2005/059056, for example, describes a primer which, in addition to an organotitanate and an organic solvent, includes a mercaptosilane and a polyaminosilane and a secondary aminosilane.

The adhesion promoter disclosed in WO-A-2005/059056, however, often has adhesion problems, in particular on glass and glass ceramics and in particular after poultice storage.

### SUMMARY

The aim of the present disclosure is to provide adhesion promoters which exhibit good adhesion for one-component, moisture-curing polyurethane adhesives, in particular to glass and glass ceramics, and in particular after poultice storage.

It has now surprisingly been discovered that this aim can be achieved by means of the compositions according to embodiments.

The compositions are suitable in particular as primers for one-component moisture-curing polyurethane adhesives, and are advantageously used for bonding glass and glass ceramic. They have been shown to be especially suitable when used as primers for glazing means of transport, in particular road and track vehicles.

Further advantageous embodiments of the disclosure are the found in the compositions according to embodiments.

### DETAILED DESCRIPTION OF EMBODIMENTS

The subject matter of the present disclosure are compositions which have i) at least one mercaptosilane MS, as well as ii) at least one polysilane PS, as well as iii) at least one aromatic secondary aminosilane AS, as well as iv) at least one organotitanium compound.

In this document, the term “organoalkoxysilane” or “organoacyloxysilane,” or “silane” for short, means compounds in which first of all at least one, usually 2 or 3 alkoxy groups or acyloxy groups are bonded directly to the silicon atom (through an Si—O bond) and that secondly have at least one organic radical directly bonded to the silicon atom (through a Si—C bond) and have no Si—O—Si bonds. Accordingly, the term “silane group” means the silicon-containing group bonded to the organic radical of the organoalkoxysilane. The organoalkoxysilanes or organoacyloxysilanes, or their silane groups, have the property that they undergo hydrolysis when in contact with moisture. Organosilanols are thus formed, i.e., organosilicon compounds containing one or more silanol groups (Si—OH groups) and, by means of subsequent condensation reactions, organosiloxanes are formed, i.e., organosilicon compounds containing one or more siloxane groups (Si—O—Si groups).

Silanes having amino, mercapto, or oxirane groups in the organic radical bonded to the silicon atom of the silane group are called “aminosilanes,” “mercaptosilanes,” or “epoxysilanes.” A primary aminosilane has a primary amino group —NH₂.

A secondary aminosilane has a secondary amino group —NH—. An aromatic secondary aminosilane has an aromatic secondary amino group. In the aromatic secondary amino group, the secondary amino group is directly bonded to an aromatic radical, as is the case, for example, in N-methylaniline. A tertiary aminosilane has a tertiary amino group

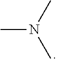

In this document, substance names beginning with “poly”, such as polysilane, polyol, polyisocyanate, polymercaptan, or polyamine, denote substances that formally contain 2 or more of the functional groups appearing in their name per molecule.

In this document, the use of the term “each independently” in connection with substituents, radicals, or groups means that substituents, radicals, or groups having the same designation can appear at the same time in the same molecule with different meanings.

Suitable mercaptosilanes MS for the composition preferably have formula (II).

HS—R¹—Si(OR²)_{(3-c)}(R³)_{c} (II)

R² each independently stands here for an alkyl group with 1 to 4 C atoms or an acyl group with 1 to 4 C atoms, preferably for methyl. Furthermore, R³ each independently stands for H or for an alkyl group with 1 to 10 C atoms, and R¹ stands for a linear or branched alkylene group with 1 to 6 C atoms, in particular for propylene, and c stands for 0, 1, or 2, preferably 0.

Suitable mercaptosilanes MS are mercaptosilanes which are selected from the group consisting of mercaptomethyl trimethoxysilane, mercaptomethyl triethoxysilane, mercaptomethyl dimethoxymethylsilane, mercaptomethyl diethoxymethylsilane, 3-mercaptopropyl trimethoxysilane, 3-mercaptopropyl triethoxysilane, 3-mercaptopropyl triisopropoxysilane, 3-mercaptopropyl methoxy(l,2-ethylenedioxy)silane, 3-mercaptopropyl methoxy(l,2-propylenedioxy)silane, 3-mercaptopropyl ethoxy(l,2-propylenedioxy)silane, 3-mercaptopropyl dimethoxymethylsilane, 3-mercaptopropyl diethoxymethylsilane, 3-mercapto-2-methylpropyl trimethoxysilane, and 4-mercapto-3,3-dimethylbutyl trimethoxysilane.

3-Mercaptopropyl trimethoxysilane and 3-mercaptopropyl triethoxysilane, in particular 3-mercaptopropyl trimethoxysilane are preferred as mercaptosilanes MS.

The composition typically contains at least one mercaptosilane MS with a proportion by weight of mercaptosilane MS of 0.5-10 wt. %, in particular 1-7 wt. %, preferably 2-5 wt. %, based on the weight of the composition.

In embodiments, a suitable polysilane PS is a polysilane PS1 which has at least one secondary or tertiary amino group. In a second embodiment, a suitable polysilane PS2 can be obtained from reaction of an aminosilane or mercaptosilane with a polyisocyanate or with an isocyanate group-containing polyurethane polymer.

Polysilane PS1 has at least one secondary or tertiary amino group, in particular a secondary amino group. Aminosilanes of formula (III) are particularly suitable.

R⁴[—Si(OR⁵)₍₃₋ₐ₎(R⁶)ₐ]ₙ (III)

Here R⁴ stands for an n-valent organic radical with at least one secondary or tertiary amino group. R⁵ each independently stands for an alkyl group with 1 to 4 C atoms or an acyl group with 1 to 4 C atoms. The subscript a stands for 0, 1, or 2. Furthermore, R⁶ each independently stands for H or for an alkyl group with 1 to 10 C atoms and n stands for 2, 3, or 4.

The subscript n especially preferably stands for 2 or 3, i.e., polysilane PS1 preferably has 2 or 3 silane groups. Polysilanes PS1 having 2 silane groups are preferred. Polysilanes PS1 with a=0 are preferred. Methyl, ethyl, propyl, and butyl groups as well as their positional isomers are preferred as R⁵. R⁵ is most preferably a methyl group.

Polysilanes with formula (IV) are suitable as polysilanes PS1.

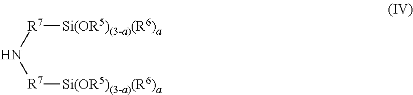

R⁷ stands here for a linear or branched alkylene group with 1 to 6 C atoms, in particular for a propylene group.

Suitable as polysilanes PS 1 are bis(3-trimethoxysilylpropyl)amine and bis(3-triethoxysilylpropyl)amine. Bis(3-trimethoxysilylpropyl)amine is preferred as polysilane PS1.

Polysilanes which have at least one structural element of formula (V) or (VI), in particular formula (V-1) or (VI-1), are also preferred as polysilanes PS1.

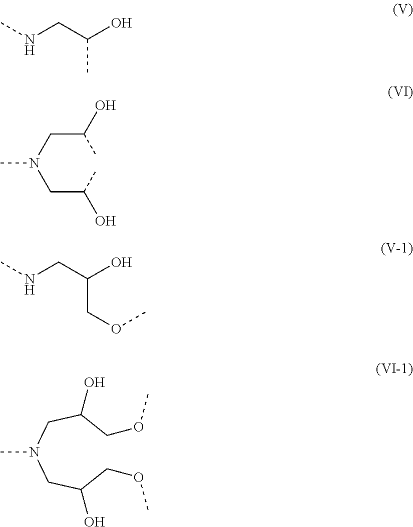

Such polysilanes PS1 of formula V and VI, or V-1 and VI-1, can be synthesized by reaction of primary or secondary amines with epoxides or with glycidyl ethers. The silane groups can come from either the amine or the epoxide or glycidyl ether. The dashed lines in the formulas in this document in each case represent bonding between the respective substituents and the corresponding molecular moiety.

Such polysilanes PS1 are firstly, for example, reaction products between 3-aminopropyl trimethoxysilane or bis(3-trimethoxysilylpropyl)amine and bisphenol-A diglycidyl ether or hexanediol diglycidyl ether.

Such polysilanes PS1 are secondly, for example, reaction products between an epoxysilane of formula (VII) and an aminosilane of formula (VIII).

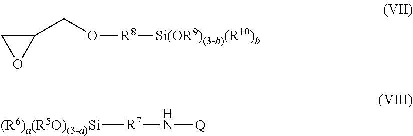

R⁹ each independently stands here for an alkyl group with 1 to 4 C atoms or an acyl group with 1 to 4 C atoms. R⁹ preferably stands for a methyl group. R¹⁰ each independently stands for an H or for an alkyl group with 1 to 10 C atoms. R⁷ and R⁸ each independently stand for a linear or branched alkylene group with 1 to 6 C atoms, in particular for propylene. Q stands for H or for an alkyl, cycloalkyl, or aryl radical with 1 to 20 C atoms or a radical of formula —(CH₂—CH₂—NH)_{d}H or for a radical of formula —R⁷Si(OR⁵)₍₃₋ₐ₎(R⁶)ₐ. The subscript b stands for 0, 1, or 2, preferably for 0. The subscript d stands for 1 or 2.

R⁶, R⁵, and a have the meanings already described for formula (III).

Such polysilanes PS1 can have a structure of formula (IX).

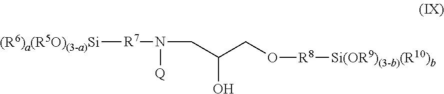

Suitable as polysilane PS1, which has at least one secondary or tertiary amino group, are reaction products between 3-aminopropyl trimethoxysilane or bis(3-trimethoxysilylpropyl)amine and 3-glycidyloxypropyl trimethoxysilane.

Polysilanes which are obtained from reaction of at least one aminosilane or mercaptosilane of formula (X) with at least one polyisocyanate or with at least one isocyanate group-containing polyurethane polymer are especially suitable as polysilanes PS2. Such polysilanes PS2 have in particular formula (X1).

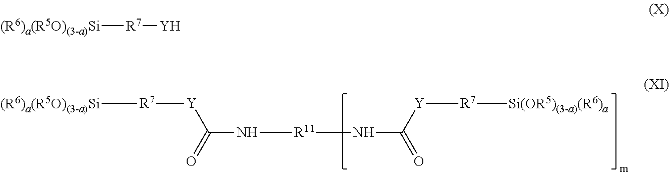

Here Y stands for NQ or S. Furthermore, R¹¹ stands for a polyisocyanate or isocyanate group-containing polyurethane polymer after removal of m NCO groups, and m stands for 1, 2, or 3, in particular for 1 or 2.

Suitable aminosilanes of formula (X) are aminosilanes with primary amino groups which are selected from the group consisting of 3-aminopropyl trimethoxysilane, 3-aminopropyl dimethoxymethylsilane, 3-amino-2-methylpropyl trimethoxysilane, 4-aminobutyl trimethoxysilane, 4-aminobutyl dimethoxymethylsilane, 4-amino-3-methylbutyl trimethoxysilane, 4-amino-3,3-dimethylbutyl trimethoxysilane, 4-amino-3,3-dimethylbutyl dimethoxymethylsilane, 2-aminoethyl trimethoxysilane, 2-aminoethyl dimethoxymethylsilane, aminomethyl trimethoxysilane, aminomethyl dimethoxymethylsilane, and aminomethyl methoxydimethylsilane. 3-Aminopropyl trimethoxysilane and 3-aminopropylmethyl dimethoxysilane are preferred.

Aminosilanes with secondary amino groups can also be used as aminosilanes of formula (X), although the reaction will take longer. Suitable aminosilanes are those with secondary amino groups which are selected from the group consisting of N-methyl-3-aminopropyl trimethoxysilane, N-ethyl-3-aminopropyl trimethoxysilane, N-butyl-3-aminopropyl trimethoxysilane, N-cyclohexyl-3-aminopropyl trimethoxysilane, N-phenyl-3-aminopropyl trimethoxysilane, N-methyl-3-amino-2-methylpropyl trimethoxysilane, N-ethyl-3-amino-2-methylpropyl trimethoxysilane; N-ethyl-3-aminopropyl dimethoxymethylsilane, N-phenyl-4-aminobutyl trimethoxysilane, N-phenylaminomethyl dimethoxymethylsilane, N-cyclohexylaminomethyl dimethoxymethylsilane, N-methylaminomethyl dimethoxymethylsilane, N-ethylaminomethyl dimethoxymethylsilane, N-propylaminomethyl dimethoxymethylsilane, N-butylaminomethyl dimethoxymethylsilane; N-(2-aminoethyl)-3-aminopropyl trimethoxysilane, 3-[2-(2-aminoethylamino)ethylamino]propyl trimethoxysilane, N-(2-aminoethyl)-3-aminopropylmethyl dimethoxysilane, 3-[2-(2-aminoethylamino)ethylamino]propylmethyl dimethoxysilane, bis(3-trimethoxysilylpropyl)amine, and bis(3-triethoxysilylpropyl)amine.

Suitable examples of aminosilanes of formula (X) with secondary amino groups are N-butyl-3-aminopropyl trimethoxysilane, N-methyl-3-aminopropyl trimethoxysilane, N-phenyl-3-aminopropyl trimethoxysilane, or bis(3-trimethoxysilylpropyl)amine.

The aforementioned mercaptosilanes MS are particularly suitable as mercaptosilanes of formula (X).

Suitable polyisocyanates are in particular diisocyanates or triisocyanates. Commercially available preferred polyisocyanates are, for example, 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane-1,3- and -1,4-diisocyanate and any mixture of these isomers, 1-isocyanato-3,3,5-trimethyl-5-isocyanatomethylcyclohexane (=isophorone diisocyanate or IPDI), perhydro-2,4′- and perhydro-4,4′-diphenylmethane diisocyanate (HMDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and 1,4-xylylene diisocyanate (m- and p-TMXDI), bis-(1-isocyanato-1-methylethyl)naphthalene, 2,4- and 2,6-toluylene diisocyanate and any mixtures of these isomers (TDI), 4,4′-, 2,4′-, and 2,2′-diphenylmethane diisocyanate and any mixtures of these isomers (MDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), as well as any mixtures of the aforementioned isocyanates and their biurets or their isocyanurates. MDI, TDI, HDI, and IPDI and their biurets or isocyanurates are especially preferred.

Isocyanate group-containing polyurethane polymers can be obtained in particular by a method known in the prior art from the just named polyisocyanates and polyols and/or polyamines, such as are disclosed in the patent US 2006/0122352 A1 in paragraphs [0029] to [0041] and [0043] to [0044], the contents of which in particular are incorporated herein by reference.

An advantage of PS1 over PS2 as polysilanes PS is that they have better solubility and lower viscosity. They also are commercially available and are distinguished by a lower price.

A polysilane of formula (IV) is preferred in particular as polysilane PS; polysilane PS is preferably a bis(3-trimethoxysilylpropyl)amine or bis(3-triethoxysilylpropyl)amine.

The composition typically contains at least one polysilane PS with a proportion by weight of polysilane PS of 0.1-10 wt. %, in particular 0.5-7 wt. %, preferably 1-5 wt. %, based on the weight of the composition.

The composition has an aromatic secondary aminosilane AS. Aromatic secondary aminosilanes AS suitable for the composition preferably have formula (I) or formula (I′).

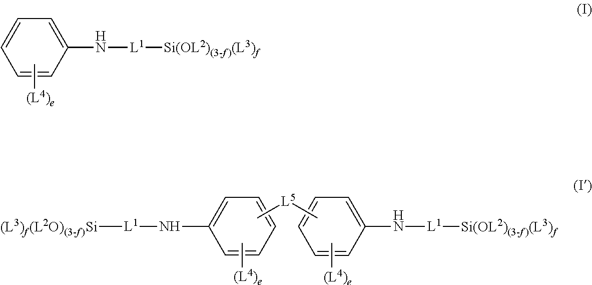

L¹ stands here for a linear or branched alkylene group, in particular with 1 to 5 C atoms, preferably with 3 or 4 C atoms. Furthermore L² each independently stands for an alkyl group with 1 to 4 C atoms or an acyl group with 1 to 4 C atoms, preferably for a methyl group. L³ each independently stands for an H or for an alkyl group with 1 to 10 C atoms. Furthermore, L⁴ each independently stands for an optionally branched alkyl radical with 1 to 5 C atoms, an optionally branched alkoxy radical with 1 to 5 C atoms, an optionally branched ester radical with 1 to 5 C atoms, NO₂, or halogen atoms. In particular, e stands for 0. Furthermore, L⁵ stands for an optionally branched alkylene radical with 1 to 5 C atoms. Also fstands for 0, 1, or 2, and e stands for an integer from 0 to 3.

Suitable aromatic secondary aminosilanes are selected from the group consisting of N-((trimethoxysilyl)methyl)aniline, N-((triethoxysilyl)methyl)aniline, N-(3-(dimethoxy(methypsilyl)-2,2-dimethylpropyl)aniline, N-(3-(trimethoxysilyl)propyl)aniline, N-(3-(triethoxysilyl)propyl)aniline, N-(4-(trimethoxysilyl)butyl)aniline, N-(5-(trimethoxysilyl)pentyl)aniline, and N-(3-(diethoxy(methyl)silyl)-2-methylpropyl)aniline.

Examples of aromatic secondary aminosilanes AS of formula (I′) are 4,4′-methylenebis(N-(3-(trimethoxysilyl)propyl)aniline), 4,4′-(propane-2,2-diyl)bis(N-(3-(trimethoxysilyl)propyl)aniline), and 4,4′-methylenebis(2-methyl-N-(3(trimethoxysilyl)propyl)aniline).

Preferred aromatic secondary aminosilanes AS are N-(3-(trimethoxysilyl)propyl)aniline and N-(3-(triethoxysilyl)propyl)aniline, in particular N-(3-(trimethoxysilyl)propyl)aniline.

The composition typically contains at least one aromatic secondary aminosilane AS with a proportion by weight of aromatic secondary aminosilane AS of 0.1-10 wt. %, in particular 0.5-7 wt. %, preferably 1-5 wt. %, based on the weight of the composition.

The composition contains an organotitanium compound. Here the organotitanium compound has at least one substituent bonded to the titanium atom through an oxygen—titanium bond, in particular four substituents bonded to the titanium atom through an oxygen—titanium bond.

Suitable substituents bonded to the titanium atom through an oxygen—titanium bond are substituents which are selected from the group consisting of an alkoxy group, sulfonate group, carboxylate group, dialkyl phosphate group, dialkyl pyrophosphate group, and acetylacetonate group.

Suitable compounds are those in which all the substituents bonded to the titanium are selected from the group consisting of an alkoxy group, sulfonate group, carboxylate group, dialkyl phosphate group, dialkyl pyrophosphate group, and acetylacetonate group, where all substituents can be the same or different from each other. Substituents with 4 to 8 C atoms are preferred.

These substituents are preferably identical.

Organotitanium compounds are commercially available, for example from Kenrich Petrochemicals DuPont. Examples of suitable organotitanium compounds are, for example, KEN-REACT® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals or TYZOR® ET, TBT, TOT, TPT, NPT, BTM, AA, AA-75, AA-95, AA-105, TE, ETAM, OGT from DuPont.

KEN-REACT® KR 7, KR 9S, KR 12, KR 26S, KR 38S, KR44, LICA 09, LICA 44, NZ 44, as well as TYZOR® ET, TBT, TOT, TPT, NPT, BTM, AA, AA-75, AA-95, AA-105, TE, ETAM, OGT from DuPont are preferred. Tetra(n-butyl) titanate, i.e., TYZOR® TBT, and octylene glycol titanate, i.e. TYZOR® OGT, are especially preferred.

It is clear to the person skilled in the art that these organotitanium compounds hydrolyze under the influence of water, and OH groups bonded to the titanium atom are formed. Such hydrolyzed or partially hydrolyzed organotitanium compounds can then themselves condense and form condensation products which have Ti—O—Ti bonds. If silanes and/or titanates are mixed as adhesion promoters, mixed condensation products are also possible which have Si—O—Ti bonds. A small proportion of such condensation products is possible, in particular if they are soluble, emulsifiable, or dispersible.

The composition typically contains at least one organotitanium compound with a proportion by weight of the organotitanium compound of 0.5-15 wt. %, in particular 1-12 wt. %, preferably 2-10 wt. %, based on the weight of the composition.

In one possible embodiment, the composition additionally includes at least one epoxy resin EP. Suitable epoxy resins EP are in particular epoxy resins of formula (XII).

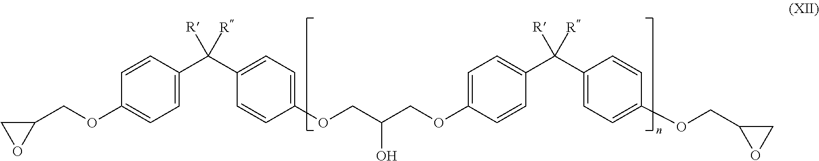

Here the substituents R′ and R″ each independently stand for either H or CH₃. The subscript s stands for a number from 0 to 20.

Compounds of formula (XII) with a subscript s>1.5, in particular from 2 to 12, are called solid epoxy resins. Such solid epoxy resins are commercially available, for example, from Dow Chemical or Huntsman or Hexion, for example as D.E.R.™ 671 or D.E.R.™ 692 (Dow) or Araldite® GT 7071 (Huntsman).

Compounds of formula (XII) with a subscript s between 1 and 1.5 are called semisolid epoxy resins by the person skilled in the art. For the present invention here, they are also considered as solid resins. However, solid epoxy resins in the narrower sense are preferred, i.e., for which the subscript s has a value >1.5. The term “solid epoxy resin” is very familiar to the person skilled in the art of epoxides, and is used in contrast to “liquid epoxy resins.” The glass transition temperature of solid epoxy resins is above room temperature, i.e., at room temperature they can be broken up into free-flowing powders or granulates.

Compounds of formula (XII) with a subscript s between 0 and 1 are called liquid epoxy resins. The subscript s preferably stands for a number less than 0.2.

These compounds therefore include, for example, diglycidyl ether of bisphenol A (DGEBA), diglycidyl ether of bisphenol F, as well as diglycidyl ether of bisphenol A/F (the designation “A/F” here refers to a mixture of acetone and formaldehyde used as a starting material in its manufacture).

Such liquid resins are available, for example, as ARALDITE® GY 250, ARALDITE® PY 304, ARALDITE® GY 282 (Huntsman), or D.E.R.® 331, or D.E.R.® 336 (Dow), or D.E.R.® 330 (Dow), or Epikote 828 (Hexion).

Furthermore, “novolacs” are suitable as epoxy resin EP. These have in particular the following formula:

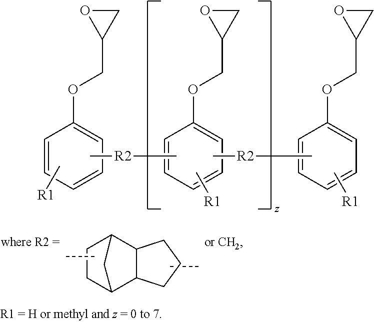

Here these can be in particular phenol or cresol novolacs (R2=CH₂).

Such novolacs are commercially available under the trade names EPN or ECN as well as TACTIX® from Huntsman or as the D.E.N.® product line from Dow Chemical.

Epoxy resin EP is preferably a solid epoxy resin of formula (XII) with a subscript s>1.5, in particular from 2 to 12.

If the composition contains epoxy resin EP, in principle the latter can react with mercaptosilane MS or polysilane PS or with other epoxy group-reactive groups present in the composition.

It is furthermore advantageous if the epoxy resin EP has an epoxide equivalent weight (EEW) of 300 g/eq-2000 g/eq, in particular 400 g/eq-1000 g/eq.

The proportion by weight of epoxy resin EP used in the composition is advantageously 1-40 wt. %, in particular 1.5-20 wt. %, preferably 2-10 wt. %, based on the weight of the composition.

It has been proven to be advantageous if the composition contains at least one solvent, in particular at least one organic solvent. Suitable organic solvents include in particular hydrocarbons or ketones or carboxylic acid esters or alcohols. Preferred examples of suitable organic solvents are toluene, xylene, hexane, heptane, methyl ethyl ketone, acetone, butyl acetate, ethyl acetate, ethanol, isopropanol, methanol. Hexane, heptane, methyl ethyl ketone, acetone, butyl acetate, ethyl acetate, ethanol, isopropanol, methanol are especially preferred. Furthermore, there are specific embodiments in which water is also suitable as a solvent, optionally mixed with an organic solvent.

The solvent is used in particular in an amount of 40-99 wt. %, in particular 60-95 wt. %, based on the weight of the composition.

The composition can additionally contain at least one adhesion promoter, in particular at least one silane or at least one organozirconium compound.

Suitable adhesion promoter substances include in particular tetraalkoxysilanes, organoalkoxysilanes, and organozirconium compounds as well as mixtures thereof. In addition to the already mentioned aminosilanes, epoxysilanes, and mercaptosilanes, the organoalkoxysilanes include in particular (meth)acrylatosilane and vinylsilane, in particular 3-(meth)acryloxypropyl triethoxysilane, 3-(meth)acryloxypropyl trimethoxysilane, vinyl trimethoxysilane and vinyl triethoxysilane.

The composition can optionally have additional components. Such additional components, however, should not negatively affect the storage stability of the composition. Additional components are, for example, catalysts, luminescent indicators such as UVITEX® OB from Ciba Specialty Chemicals, stabilizers, surfactants, acids, dyes and pigments.

The composition preferably contains or the composition preferably consists of a mercaptosilane MS, in particular 3-mercaptopropyl trimethoxysilane, in an amount of 2-5 wt. % based on the total weight of the composition, a polysilane PS, in particular bis(3-trimethoxysilylpropyl)amine, in an amount of 1-5 wt. % based on the total weight of the composition, an aromatic secondary aminosilane AS, in particular N-(3-(trimethoxysilyl)propyl)aniline, in an amount of 1-5 wt. % based on the total weight of the composition, an organotitanium compound, in particular tetra(n-butyl) titanate or octylene glycol titanate, in an amount of 2-10 wt. % based on the total weight of the composition, and a solvent, in particular heptane, in an amount of 60-95 wt. % based on the total weight of the composition.

In the composition, the mole ratio of all mercaptosilanes MS used in the composition to all the polysilanes PS used in the composition to all the aromatic secondary aminosilanes AS used in the composition to all the organotitanium compounds used in the composition is preferably from 1 to 0.05-1.5 to 0.05-1.5 to 0.1-3, in particular from 1 to 0.1-1.2 to 0.1-1.2 to 0.1-1.5.

The composition is exceptionally suitable as an adhesion promoter and can be widely used. In particular it can be used as a primer or as a primer component. By primer is meant a primer coat which is applied to a surface and, after a certain waiting period after application (the “flash-off time”), is covered by an adhesive or sealant or coating and also improves the adhesion of the adhesive or sealant or coating to the respective substrate surface.

The composition is thus suitable for use as an adhesive primer for a substrate S1, where substrate S1 in particular is glass or glass ceramic.

But the composition can also be used as an adhesion promoter in an adhesive or sealant or coating. Use in an adhesive or sealant is particularly suitable.

There are various options for use of the composition as an adhesion promoter:

A first method for bonding or sealing two substrates S1 and S2 includes at least the following steps:
a) Application of a composition, as described above, to a first substrate S1
b) Application of an adhesive or sealant to the flashed off composition, applied as in step a)
c) Bringing the adhesive or sealant into contact with a second substrate S2.

A second method for bonding or sealing two substrates S1 and S2 includes at least the following steps:
a′) Application of a composition, as described above, to a first substrate S1
b′) Application of an adhesive or sealant to the surface of a second substrate S2
c′) Bringing the adhesive or sealant into contact with the flashed off composition, which is on substrate S1.

A third method for bonding or sealing two substrates S1 and S2 includes at least the following steps:
a″) Application of a composition, as described above, to a first substrate S1
b″) Application of an adhesive or sealant to the first substrate S1 and the second substrate S2, where a composition has been applied as in step a″) to at least one of the substrates
c″) Bringing the applied adhesives or sealants into contact with each other, joining the substrate pieces to form an adhesive bond or a sealant bond.

A fourth method for bonding or sealing two substrates S1 and S2 includes at least the following steps:
a′″) Application of a composition, as described above, to a first substrate S1
b′″) Flashing off of the composition
c′″) Application of an adhesive or sealant between the surfaces of substrate S1 and S2.

In all four options, the second substrate S2 consists of material which is the same as or different from substrate S1.

A step of curing the adhesive or sealant typically follows step c), c′), c″), or c′″). The person skilled in the art understands that depending on the system used and the reactivity of the adhesive, crosslinking reactions and thus curing can begin even during application. But most of the crosslinking, and thus in a narrower sense of the term, the curing, occurs after application; otherwise, problems arise with development of adhesion to the substrate surface.

At least one of substrates S1 or S2 in particular is glass or glass ceramic. In particular, one substrate is glass or glass ceramic and the other substrate is lacquer or lacquered metal or lacquered metal alloy. Thus substrate S1, or S2, is glass or glass ceramic and substrate S2, or S1, is a lacquer or lacquered metal or lacquered metal alloy.

Adhesives or sealants can be one-component or two-component adhesives or sealants.

Suitable one-component adhesives or sealants contain in particular moisture-curing isocyanate group-terminated polymers. Such adhesives or sealants are crosslinked under the influence of water, in particular moisture in the air. Examples of such one-component moisture-curing polyurethane adhesives are those from the SIKAFLEX® and SIKATACK® product lines, such as are commercially available from Sika Schweiz AG.

The above-mentioned isocyanate-terminated polymers are synthesized from polyols, in particular polyoxyalkylene polyols, and polyisocyanates, in particular diisocyanates.

Suitable two-component adhesives or sealants are two-component polyurethane adhesives or sealants where the first component includes an amine or polyol and the second component includes an NCO-containing polymer or a polyisocyanate. Examples of such two-component room temperature-curing polyurethane adhesives are those from the SIKAFORCE® product line, such as are commercially available from Sika Schweiz AG.

It has been shown that in particular for moisture-curing polyurethane adhesives or sealants, a considerable improvement can be achieved in adhesion, in particular to glass and glass ceramics and in particular after poultice storage, when using the described composition.

These adhesive bonding and sealing methods are used in particular in manufacture of articles, in particular means of transport. Such articles are in particular automobiles, busses, freight vehicles, track vehicles, ships, or aircraft.

The most preferred application is glazing means of transport, in particular road and track vehicles.

### EXAMPLES

Different compositions were prepared, consisting of the ingredients in parts by weight as indicated in Table 1. Compositions Ref1 to Ref5 represent Comparison Examples.

### Raw Materials Used:

A-189 3-mercaptopropyl trimethoxysilane SILQUEST® A189, GE Silicones, Switzerland
A-1170 Bis(trimethoxysilylpropyl)amine SILQUEST® A1170, GE Silicones, Switzerland
NPAPTS N-phenyl-3-aminopropyl trimethoxysilane, Sigma-Aldrich Chemie GmbH, Switzerland
A-1120 N-(2-aminoethyl)-3-aminopropyl trimethoxysilane SILQUEST® A1120, GE Silicones, Switzerland
OGT octylene glycol titanate, TYZOR® OGT, DuPont, USA
TBT tetra(n-butyl) titanate, TYZOR® TBT, DuPont, USA

Preparation of Compositions

Using the amounts specified in Table 1, for the compositions the solvent together with optionally present additional ingredients were mixed at 23° C. with exclusion of moisture from the air. Comparison Example Ref5 represents Example 23 from WO-A-2005/059056.

TABLE 1
Ingredients of compositions in parts by weight.

| Ingredients | 1 | 2 | 3 | 4 | 5 | 6 |
|---|---|---|---|---|---|---|
| A-189 | 3.5 | 3.5 | 3.5 | 3.5 | 3.5 | 3.5 |
| A-1170 | 1.7 | 1.7 | 1.7 | 1.7 | 1.7 | 1.8 |
| NPAPTS | 1.7 | 1.7 | 1.7 | 1.7 | 1.7 | 1.7 |
| OGT | 5.0 | 5.0 | 2.5 | — | — | 5.0 |
| TBT | — | — | — | 5.0 | 2.7 | — |
| Toluene | — | — | — | — | — | 88.0 |
| Heptane | 88.1 | 138.1 | 90.6 | 88.1 | 90.4 | — |
| Total | 100 | 150 | 100 | 100 | 100 | 100 |

| Ingredients | Ref1 | Ref2 | Ref3 | Ref4 | Ref5 |
|---|---|---|---|---|---|
| A-189 | 3.7 | 3.5 | 3.5 | 3.7 | 3.3 |
| A-1170 | — | — | 1.7 | 3.7 | 0.2 |
| NPAPTS | 3.7 | 3.5 | — | — | — |
| A-1120 | — | — | — | — | 0.4 |
| OGT | — | 5.0 | — | — | 3.0 |
| TBT | — | — | — | — | — |
| Toluene | 92.6 | — | — | 92.6 | 73.1 |
| Heptane | — | 88.0 | 94.8 | — | — |
| Total | 100 | 100 | 100 | 100 | 80 |

Test Methods

Application and Curing

For the tests in Tables 2 and 3, the compositions were applied to each substrate by the “wipe on/off” method using a wipe (TELA®, Tela-Kimberly Switzerland GmbH).

The following were used as substrates:
Glass ceramic, rear window of a Mercedes Benz, Daimler AG, S-Class, BR 221, PPG (“Sub1”),
Glass ceramic, rear window of a Mercedes Benz, Daimler AG, C-Class, BR 203, PPG (“Sub2”),
Standard flat glass, tin side, Rocholl GmbH, Germany (“Glass”).

After a flash-off time of 10 minutes, the adhesives were applied as a round bead with a cartridge squeezing device and a nozzle to the substrate surface, coated with the composition. The adhesive temperature was 60° C. during application.

The adhesives used were the one-component polyurethane adhesives SIKAFLEX®-250 DM-2 (“DM2”) or SIKAFLEX®-250 DM-3 (“DM3”), which are commercially available from Sika Schweiz AG.

Then the adhesive was cured for 7 days at 23° C. and 50% relative air humidity (storage in a room temperature environmental chamber: EC) and a third of the bead was tested by means of the adhesion test described below. Then the test sample was stored in water for another 7 days at 23° C. (water storage: WS). The adhesion was subsequently tested by the bead test for another third of the bead. Then the substrates were put in poultice storage (100% relative air humidity and 70° C.: PS) and the adhesion of the last third of the bead was subsequently determined.

Adhesion Test (“Bead Test”)

The adhesion of the adhesive was tested using the “bead test”. For this, the bead is cut at the end just above the adhesive surface. The cut end of the bead is held with round-tip forceps and pulled from the substrate. This is done by carefully rolling up the bead on the tip of the forceps, and placing a cut perpendicular to the direction in which the bead is pulled, down to the bare substrate. The bead peel rate should be selected so that a cut must be made approximately every 3 seconds. The test distance must be at least 8 cm. The adhesive remaining on the substrate after peeling off the bead is assessed (cohesive failure). The adhesive properties are assessed by estimating the area fraction of cohesive failure on the bonding surface:

TABLE 2
Adhesion results after different types of storage.

| | | 1 | | | 2 | | | 3 | | | 4 | | | 5 | | | Ref3 | | |
|---|---|---|---|---|---|---|---|---|---|---|---|---|---|---|---|---|---|---|---|
| Substrate | Adhesive | EC | WS | PS | EC | WS | PS | EC | WS | PS | EC | WS | PS | EC | WS | PS | EC | WS | PS |
| Sub1 | DM2 | 1 | 1 | 3 | 1 | 1 | 3 | 1 | 2 | 3 | 1 | 1 | 3 | 1 | 1 | 2 | 4 | 4 | 4 |

1 >95% cohesive failure
2 = 76-95% cohesive failure
3 = 25-75% cohesive failure
4 <25% cohesive failure
5 = 0% cohesive failure (purely adhesive failure).

TABLE 3
Adhesion results after different types of storage.

| | | 6 | | | Ref1 | | | Ref2 | | | Ref4 | | | Ref5 | | |
|---|---|---|---|---|---|---|---|---|---|---|---|---|---|---|---|---|
| Substrate | Adhesive | EC | WS | PS | EC | WS | PS | EC | WS | PS | EC | WS | PS | EC | WS | PS |
| Sub2 | DM2 | 2 | 2 | 1 | 4 | 4 | 4 | 5 | 5 | 4 | 4 | 4 | 2 | 1 | 1 | 2 |
| | DM3 | 1 | 2 | 1 | 3 | 3 | 3 | 5 | 5 | 1 | 3 | 4 | 2 | 1 | 2 | 2 |
| Glass | DM2 | 1 | 1 | 1 | 1 | 1 | 1 | 3 | 4 | 4 | 1 | 1 | 3 | 1 | 1 | 4 |
| | DM3 | 1 | 1 | 1 | 1 | 1 | 1 | 3 | 3 | 1 | 1 | 1 | 3 | 1 | 1 | 3 |

The results from Tables 2 and 3 show that compositions 1 to 6, compared with Comparison Examples Ref1 to Ref5, are distinguished by clearly improved adhesion to glass and/or glass ceramic. This is apparent in particular in improved adhesion after poultice storage.

What is claimed:

1. A composition comprising:
i) at least one mercaptosilane MS;
ii) at least one polysilane PS having at least one secondary or tertiary amino group;
iii) at least one aromatic secondary aminosilane AS; and
iv) at least one organotitanium compound;
wherein the polysilane PS is selected from the group consisting of:
polysilanes of formula (IV): 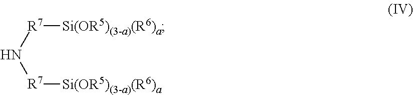
polysilanes of formula (V): 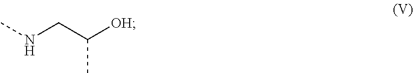
polysilanes of formula (VI): 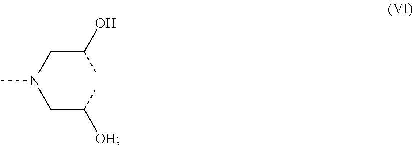
and
polysilanes that are a reaction product between an epoxysilane of formula (VII) and aminosilane of formula (VIII): 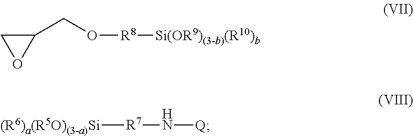
where:
R⁵ and R⁹ each independently represents an alkyl group having 1 to 4 C atoms or an acyl group having 1 to 4 C atoms;
R⁶ and R¹⁰ each independently represents an H or an alkyl group having 1 to 10 C atoms;
R⁷ and R⁸ each independently represents a linear or branched alkylene group having 1 to 6 C atoms;
Q represents:
H,
an alkyl, cycloalkyl, or aryl radical having 1 to 20 C atoms,
a radical of formula —(CH₂—CH₂—NH)_{d}H, or
a radical of formula —R⁷Si(OR⁵)₍₃₋ₐ₎(R⁶)ₐ;
a is 0, 1, or 2;
b is 0, 1, or 2;
d is 1 or 2; and
n is 2, 3, or 4.

2. The composition as in claim 1, wherein the aromatic secondary aminosilane AS has formula (I) or formula (I′) 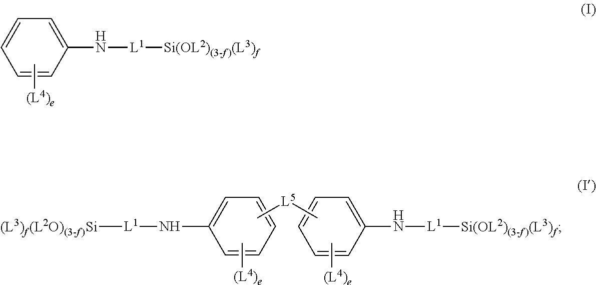
wherein L¹ stands for a linear or branched alkylene group;
L² each independently stands for an alkyl group with 1 to 4 C atoms or an acyl group with 1 to 4 C atoms;
L³ each independently stands for an H or for an alkyl group with 1 to 10 C atoms;
L⁴ each independently stands for an optionally branched alkyl radical with 1 to 5 C atoms, an optionally branched alkoxy radical with 1 to 5 C atoms, an optionally branched ester radical with 1 to 5 C atoms, NO₂, or halogen atoms;
L⁵ stands for an optionally branched alkylene radical with 1 to 5 C atoms;
f stands for 0, 1, or 2 and
e stands for an integer from 0 to 3.

3. The composition as in claim 1, wherein the organotitanium compound has four substituents bonded to the titanium atom through an oxygen-titanium bond.

4. The composition as in claim 1, wherein the proportion by weight of the mercaptosilane MS is 0.5-10 wt. %, based on the weight of the composition.

5. The composition as in claim 1, wherein the proportion by weight of the polysilane PS is 0.1-10 wt. %, based on the weight of the composition.

6. The composition as in claim 1, wherein the proportion by weight of the aromatic secondary aminosilane AS is 0.1-10 wt. %, based on the weight of the composition.

7. The composition as in claim 1, wherein the proportion by weight of the organotitanium compound is 0.5-15 wt. %, based on the weight of the composition.

8. The composition as in claim 1, wherein the composition furthermore contains at least one solvent selected from the group consisting of hydrocarbons, ketones, carboxylic acid esters and alcohols, in an amount of 40-99 wt. %, based on the weight of the composition.

9. The composition as in claim 1, wherein the composition additionally contains at least one epoxy resin, in an amount of 1-40 wt. %, based on the weight of the composition.

10. The composition as in claim 9, wherein the epoxy resin has an epoxide equivalent weight (EEW) of 300 g/eq-2000 g/eq.

11. The composition as in claim 1, wherein the mole ratio of all mercaptosilanes MS used in the composition to all the polysilanes PS used in the composition to all the aromatic secondary aminosilanes AS used in the composition to all the organotitanium compounds used in the composition is from 1 to 0.05-1.5 to 0.05-1.5 to 0.1-3.

12. An adhesive primer for a substrate S1 comprising the composition as in claim 1.

13. The adhesive primer as in claim 12, wherein the substrate S1 is a glass or a glass ceramic.

14. A method for bonding or sealing two substrates S1 and S2, comprising:
a) applying the composition as in claim 1 to a first substrate S1 and flashing off the applied composition;
b) applying an adhesive or a sealant to the flashed off composition, applied as in step a); and
c) bringing the adhesive or sealant into contact with a second substrate S2;
or
a′) applying the composition as in claim 1 to a first substrate S1 and flashing off the applied composition;
b′) applying an adhesive or a sealant to a surface of a second substrate S2; and
c′) bringing the adhesive or sealant into contact with the flashed off composition, which is on substrate S1;
or
a″) applying the composition as in claim 1 to a first substrate S1;
b″) applying an adhesive or a sealant to the first substrate S1 and a second substrate S2, where a composition according to claim 1 has been applied as in step a″) to at least one of the substrates S1 and S2;
c″) bringing the applied adhesives or sealants into contact with each other, and joining the substrates to form an adhesive bond or a sealant bond;
or
a′″) applying the composition as in claim 1 to a first substrate S1;
b′″) flashing off the composition; and
c′″) applying an adhesive or a sealant between a surface of substrate S1 and a surface of a second substrate S2;
wherein the second substrate S2 consists of material which is the same as or different from substrate S1.

15. The method as in claim 14, wherein at least one substrate S1 or S2 is a glass or a glass ceramic.

16. The method as in claim 14, wherein one of substrate S1, or S2 is a glass or a glass ceramic and substrate, and one of substrate S2, or S1, is a lacquer, a lacquered metal or a lacquered metal alloy.

17. An article for manufacture prepared by a process comprising the method of claim 14.

18. The article as in claim 17, wherein the article is a means of transport.

19. The composition according to claim 1, wherein all polysilanes present in the composition each has at least one secondary or tertiary amino group, and is selected from the group consisting of polysilanes of formula (IV), polysilanes of formula (V), polysilanes of formula (VI), and polysilanes that are a reaction product between an epoxysilane of formula (VII) and aminosilane of formula (VIII).
